(19) United States
(12) Patent Application Publication
(10) Pub. No.: US 2024/0250570 A1
(43) Pub. Date: Jul. 25, 2024

(54) ELECTRIC MOTOR USING ULTRA-CONDUCTING COPPER

(71) Applicant: GM GLOBAL TECHNOLOGY OPERATIONS LLC, Detroit, MI (US)

(72) Inventors: Lei HAO, Troy, MI (US); Qigui WANG, Rochester Hills, MI (US); John S. AGAPIOU, Rochester Hills, MI (US); Thomas W. NEHL, Shelby Township, MI (US); Xiaohui DU, West Bloomfield, MI (US)

(21) Appl. No.: 18/312,029

(22) Filed: May 4, 2023

Related U.S. Application Data
(63) Continuation-in-part of application No. 18/101,395, filed on Jan. 25, 2023.

(51) Int. Cl. H02K 3/02

(52) U.S. Cl. CPC H02K 3/02

(57) ABSTRACT

An electric motor includes a stator and a rotor rotatable relative to the stator and having an air gap between the rotor and the stator, wherein at least one of the stator and the rotor include a plurality of windings formed from ultra-conducting copper foil.

### CROSS-REFERENCE TO RELATED APPLICATIONS

This application is a continuation-in-part of U.S. patent application Ser. No. 18/101,395, filed Jan. 25, 2023. The entire disclosure of the above application is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electric motors and more particularly to an electric motor having ultra-conducting copper windings.

A conventional hairpin conductor (magnet wire) is cut from extruded metal bar stock, bent into a U-shaped winding, and inserted into slots of the stator's core. AC current flowing through a single wire conductor increasingly pushes the current toward the surface “skin” of the conductor as frequency increases. Skin effect is defined as the tendency of an AC current to distribute in a non-uniform manner within a magnet wire such that the current density is largest near the surface of the conductor, and decreases with greater depths as one moves inward towards the center of the conductor. The electric current tends to avoid travel through the center of the solid conductor and flows mainly at the “skin” of the conductor, between the outer surface and a level called the “skin depth”. This physical phenomenon accelerates the wire's AC resistance in direct proportion to the frequency of the current. Over 98% of the current will flow within a layer 4 times the skin depth from the surface. This behavior is distinct from that of direct current which usually will be distributed evenly over the cross-section of the wire. Accordingly, it is desirable to find ways to eliminate the skin effect in AC motors.

The maximum conductor skin depth may be calculated as:

$${σ}_{MAX} = 2 / {ρμω}_{MAX}$$

where δ_{MAX} is the maximum conductor skin depth of the unitary hairpin bar; ρ is an electrical resistivity of an electrically conductive material of the wires; ω_{MAX} is a maximum angular current frequency as a function of the peak operating frequency of the electric machine; and μ=μᵣμ₀, where μ₀ is a vacuum permeability and μᵣ is a relative magnetic permeability of the electrically conductive material of the wires.

Litz Wire is a multi-strand round wire used to conduct alternating current (AC) at radio frequencies. Individually very small, round magnet wires are braided together which helps reduce AC losses from skin effects and proximity effects found in high-frequency windings. However, a bundle of round wire strands does not result in a very dense conductor due to excess empty space between wires.

Oak Ridge National Lab (ORNL) has designed commercially viable fabrication approaches and material formulations to produce high-performance foil/tape-based ultra-conductive coppers (UCCs). These UCC materials achieve >5% reduction in resistance, >10% increase in ampacity, and >10% improvement in strength compared with commercial pure Cu. The basic approach to UCC fabrication includes formulating stable carbon nanotube (CNT) dispersions, depositing CNTs on Copper tapes, sputtering thin copper overlayers over the CNTs, and thermal annealing.

### SUMMARY

According to an aspect of the present disclosure, an electric motor includes a stator and a rotor rotatable relative to the stator and having an air gap between the rotor and the stator, wherein at least one of the stator and the rotor include a plurality of windings formed from ultra-conducting copper foil.

According to a further aspect, all of the plurality of windings are formed from ultra-conducting copper foil.

According to a further aspect, the stator windings further include a plurality of windings made from copper wire.

According to a further aspect, the plurality of windings formed from ultra-conducting copper foil are closer to the air gap than the plurality of windings made from copper wire.

According to a further aspect, the plurality of windings formed from ultra-conducting copper foil are further from the air gap than the plurality of windings made from copper wire.

According to a further aspect, the plurality of windings formed from ultra-conducting copper foil are combined with one of copper or aluminum.

According to a further aspect, the plurality of windings formed from ultra-conducting copper foil combined with one of copper or aluminum includes the ultra-conducting copper foil being rolled with a copper or aluminum foil.

According to a further aspect, the plurality of windings formed from ultra-conducting copper foil combined with one of copper or aluminum includes the ultra-conducting copper foil sandwiched with a copper or aluminum foil.

According to a further aspect, the plurality of windings formed from ultra-conducting copper foil combined with one of copper or aluminum includes the ultra-conducting copper foil being clad with one of copper or aluminum.

According to a further aspect, the plurality of windings formed from ultra-conducting copper foil combined with one of copper or aluminum includes the ultra-conducting copper foil being wrapped around one of a copper wire and extruded copper.

According to another aspect, an electric motor includes a stator and a rotor rotatable relative to the stator and having an air gap between the rotor and the stator. The at least one of the stator and the rotor includes a plurality of windings formed from wire that is wrapped in ultra-conducting copper foil.

According to a further aspect, all of the stator windings are formed from wire that is wrapped in ultra-conducting copper foil.

According to a further aspect, the stator windings further include a plurality of windings made from copper wire.

According to a further aspect, the plurality of windings formed from wire that is wrapped in ultra-conducting copper foil are closer to the air gap than the plurality of windings made from copper wire.

According to a further aspect, the plurality of windings formed from wire that is wrapped in ultra-conducting copper foil are further from the air gap than the plurality of windings made from copper wire.

According to another aspect, an electric motor includes a stator and a rotor rotatable relative to the stator and having an air gap between the rotor and the stator. At least one of the stator and the rotor includes a plurality of windings formed from rolled ultra-conducting copper foil that is formed with a hollow cavity therethrough.

According to a further aspect, all of the stator windings are formed from ultra-conducting copper foil that is clad with one of copper or aluminum.

According to a further aspect, the stator further includes a plurality of windings made from copper wire.

According to a further aspect, the plurality of windings formed from ultra-conducting copper that is clad with one of copper or aluminum and is formed with a hollow cavity therethrough are closer to the air gap than the plurality of windings made from copper wire.

According to a further aspect, the plurality of windings formed from ultra-conducting copper that is clad with one of copper or aluminum and is formed with a hollow cavity therethrough are further from the air gap than the plurality of windings made from copper wire.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of a first process of making electric motor conductor wires according to the principles of the present disclosure;

FIG. 2 is a schematic illustration of a second process of making electric motor conductor wires according to the principles of the present disclosure;

FIG. 3 is a schematic illustration of a third process of making electric motor conductor wires according to the principles of the present disclosure;

FIG. 4 is a schematic illustration of a motor stator implementing conductor wires made according to the principles of the present disclosure;

FIG. 5 is a schematic illustration of a fourth process of making electric motor conductor wires according to the principles of the present disclosure;

FIG. 6 is a schematic illustration of a fifth process of making electric motor conductor wires according to the principles of the present disclosure;

FIG. 7 is a schematic view of a portion of an electric motor having all of the stator windings made at least in part from ultra-conducting copper foil;

FIG. 8 is a schematic view of a portion of an electric motor having the stator windings closest to an air gap between the rotor and the stator made at least in part from ultra-conducting copper foil;

FIG. 9 is a schematic view of a portion of an electric motor having the stator windings closest to an air gap between the rotor and the stator made at least in part from ultra-conducting copper foil; and

FIG. 10. is a graph of winding loss vs. frequency comparing the original copper stator windings against the windings cladded with several layers of UCC foil resulting in a reduction in winding loss at high frequency.

In the drawings, reference numbers may be reused to identify similar and/or identical elements.

### DETAILED DESCRIPTION

With reference to FIG. 4, an electric motor stator 10 is shown including a core 12 and a plurality of hairpin windings 14. The plurality of hairpin windings 14 can be made from a high frequency conductor wire produced by a process according to the principles of the present disclosure.

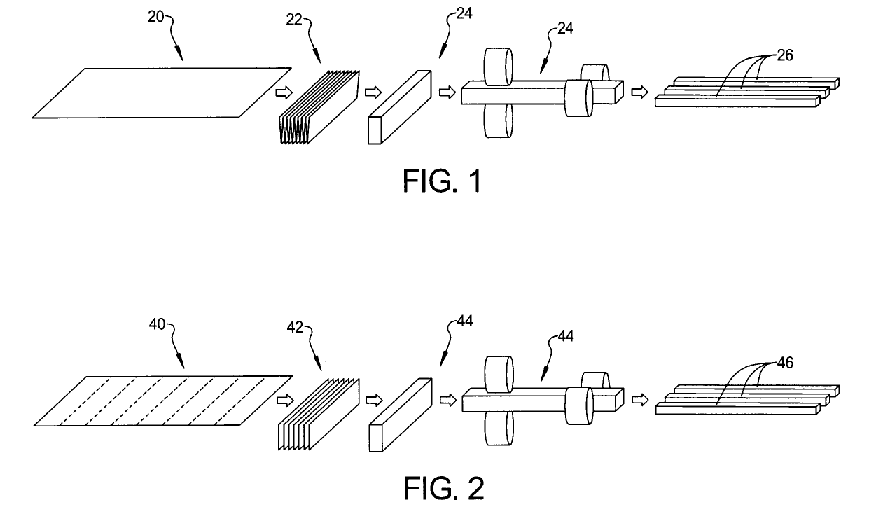

With reference to FIG. 1, a method of making the high frequency conductor wire is shown including folding an ultra-conductive copper (UCC) foil 20 is shown folded into a multiple layer folded ultra-conducting copper foil 22. The multiple layer folded ultra-conducting coper foil 22 is then cladded with one of copper and aluminum into a cladded folded ultra-conducting copper foil 24. The cladded folded ultra-conducting copper foil 24 is then plastically deformed by drawing or extrusion into one of a cladded ultra-conducting copper wire, bar, and cable 26. The ultra-conducting copper wires, bars, and cables 26 can be formed into a hairpin winding 14 that is inserted into slots of a stator core 12 of an electric motor, as shown in FIG. 4, or can otherwise be used as a high frequency electrical conductor in other applications.

The ultra-conducting copper foil 20 can include a continuous Cu tape coated with a layer of aligned carbon nanotubes. Carbon nanomaterial on or within the Cu film or thin sheet substrates may be prepared by other methods by combining carbon nanomaterials either on top or within the Cu film or thin sheet. The carbon content in the Cu-Carbon composite can be adjusted for improved electrical resistivity and/or conductivity. The ultra-conducting copper foil can be alternatively coated to provide a lower resistance than plain copper foil.

The process can include stacking a plurality of UCC foil sheets 20 and then folding the stack of UCC sheets. In addition, the UCC sheets can be stacked with plain copper sheets that are simultaneously folded into the stack of multiple layers folded ultra-conducting copper foil 22.

With reference to FIG. 2, a method of making the high frequency conductor wire is shown including stacking a plurality of strips of an ultra-conductive copper (UCC) foil 40 into a multiple layer stacked ultra-conducting copper foil 42. The multiple layers stacked ultra-conducting coper foil 42 is then cladded with one of copper and aluminum into a cladded folded ultra-conducting copper foil 44. The cladded stacked ultra-conducting copper foil 44 is then plastically deformed by drawing or extrusion into one of a cladded ultra-conducting copper wire, bar, and cable 46. The ultra-conducting copper wires, bars, and cables 46 can be formed into a hairpin winding 14 that is inserted into slots of a stator core 12 of an electric motor, as shown in FIG. 4, or can otherwise be used as a high frequency electrical conductor in other applications.

The ultra-conducting copper foil 40 can include a continuous Cu tape coated with a layer of aligned carbon nanotubes. The ultra-conducting copper foil can be alternatively coated to provide a lower resistance than plain copper foil.

The process can include stacking a plurality of UCC sheets with plain copper sheets to form the multiple layers stacked ultra-conducting copper foil 22.

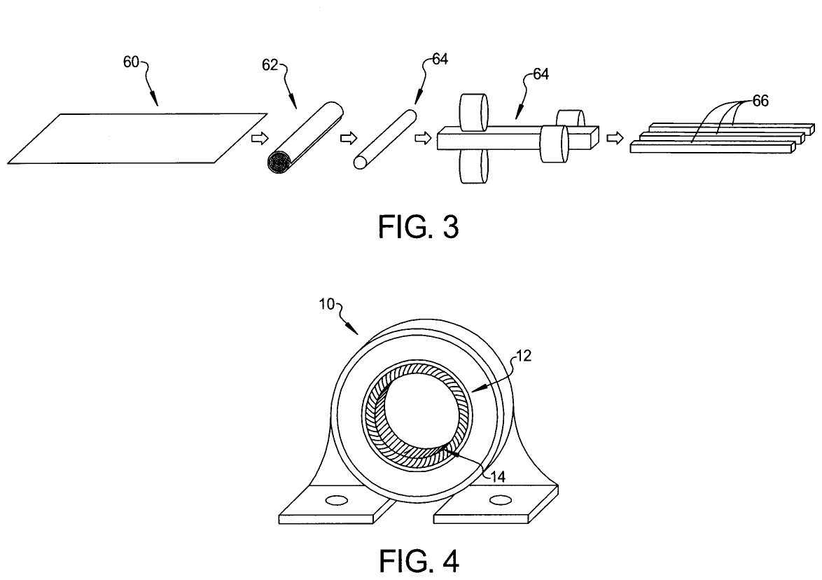

With reference to FIG. 3, a method of making the high frequency conductor wire is shown including rolling an ultra-conductive copper (UCC) foil 60 is tightly rolled into a multiple layer rolled ultra-conducting copper foil 62. The multiple layer rolled ultra-conducting coper foil 62 is then cladded with one of copper and aluminum into a cladded rolled ultra-conducting copper foil 64. The cladded rolled ultra-conducting copper foil 64 is then plastically deformed by drawing or extrusion into one of a cladded ultra-conducting copper wire, bar, and cable 66. The ultra-conducting copper wires, bars, and cables 66 can be formed into a hairpin winding 14 that is inserted into slots of a stator core 12 of an electric motor, as shown in FIG. 4, or can otherwise be used as a high frequency electrical conductor in other applications.

The ultra-conducting copper foil 60 can include a continuous Cu tape coated with a layer of aligned carbon nanotubes. The ultra-conducting copper foil 60 can be alternatively coated to provide a lower resistance than plain copper foil.

The process can include stacking a plurality of UCC sheets 60 and then rolling the stack of UCC sheets. In addition, the UCC sheets can be stacked with plain copper sheets that are simultaneously rolled into the multiple layer rolled ultra-conducting copper foil 62.

Cu with carbon nanomaterial modified wire has the advantages of higher conductivity and electrical resistivity. It is expected that the electric UCC conductor materials help reduce AC losses from skin effects and proximity effects found in high-frequency windings to achieve >5% reduction in resistance, >10% increase in ampacity, and >10% improvement in strength compared with commercial copper conductors.

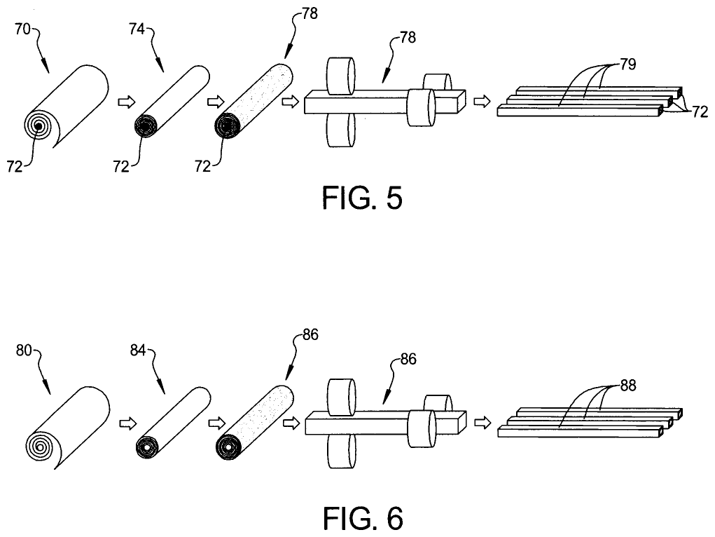

With reference to FIG. 5, a method of making the high frequency conductor wire is shown including rolling an ultra-conductive copper (UCC) foil 70 around a copper wire or extruded copper bar 72. The UCC foil 70 can be tightly rolled into a multiple layer rolled ultra-conducting copper foil 74 surrounding the copper wire or extruded copper bar 72. The multiple layer rolled ultra-conducting coper foil 74 can optionally be cladded with one of copper and aluminum into a cladded rolled ultra-conducting copper foil 78. The cladded rolled ultra-conducting copper foil 78 is then plastically deformed by drawing or extrusion into one of a cladded ultra-conducting copper wire, bar, and cable 79. The ultra-conducting copper wires, bars, and cables 79 can be formed into a hairpin winding 14 that is inserted into slots of a stator core 12 of an electric motor, as shown in FIG. 4, or can otherwise be used as a high frequency electrical conductor in other applications.

The ultra-conducting copper foil 70 can include a continuous Cu tape coated with a layer of aligned carbon nanotubes. The ultra-conducting copper foil 70 can be alternatively coated to provide a lower resistance than plain copper foil.

The process can include stacking a plurality of UCC sheets 70 and then rolling the stack of UCC sheets. In addition, the UCC sheets 70 can be stacked with plain copper sheets that are simultaneously rolled into the multiple layer rolled ultra-conducting copper foil 74 surrounding the copper wire or extruded copper bar 72.

As shown in FIG. 6, the method of making the high frequency conductor wire is shown including rolling an ultra-conductive copper (UCC) foil 80 with a hollow center. The UCC foil 80 can be tightly rolled into a hollow multiple layer rolled ultra-conducting copper foil 84. The hollow multiple layer rolled ultra-conducting coper foil 84 can then be cladded with one of copper and aluminum into a cladded hollow rolled ultra-conducting copper foil 86. The cladded hollow rolled ultra-conducting copper foil 86 is then plastically deformed by drawing or extrusion into one of a cladded hollow ultra-conducting copper wire, bar, and cable 88. The hollow ultra-conducting copper wires, bars, and cables 88 can be formed into a hairpin winding 14 that is inserted into slots of a stator core 12 of an electric motor, as shown in FIG. 4, or can otherwise be used as a high frequency electrical conductor in other applications.

The ultra-conducting copper foil 80 can include a continuous Cu tape coated with a layer of aligned carbon nanotubes. The ultra-conducting copper foil 80 can be alternatively coated to provide a lower resistance than plain copper foil.

The process can include stacking a plurality of UCC sheets 80 and then rolling the stack of UCC sheets. In addition, the UCC sheets 80 can be stacked with plain copper sheets that are simultaneously rolled into the hollow multiple layer rolled ultra-conducting copper foil 84. Since the UCC is a thin layer material, it is easy to roll it with a hole inside to form the hollow wire, as shown in FIG. 6. The wire with the hole inside can be used to pass a cooling fluid or to contain a phase change material to improve the thermal behavior of the electric motor. The hollow passages in the wire allow higher cooling performance that improves the motor performance and lighter stator weight.

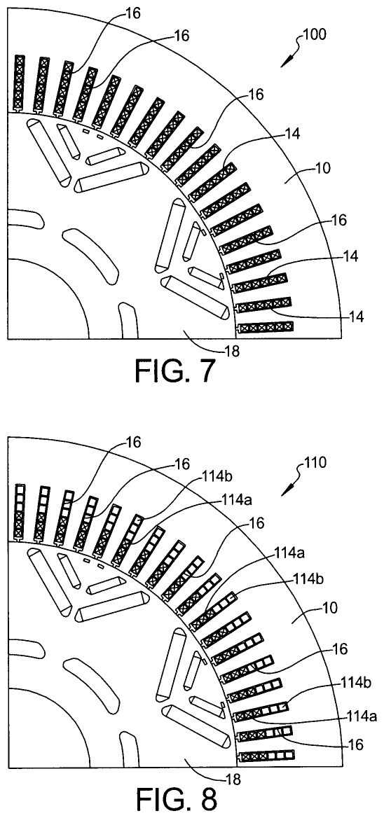

With reference to FIG. 7, a cross section of a portion of an electric motor 100 is shown including a stator 10 having a plurality of grooves 16 that receive a plurality of windings 14. A rotor 18 is rotatably received inside the stator 10 with an air gap therebetween. In the embodiment of FIG. 7, the plurality of windings 14 are all formed from UCC foils using any of the above forming techniques including rolling, stacking, folding, cladding, forming as hollow, mixing with other copper or aluminum foils, wrapping around a copper wire or extruded copper, etc.

In the embodiment of FIG. 8, a cross section of a portion of an electric motor 110 is shown including a stator 10 having a plurality of grooves 16 that receive a first plurality of windings 114a and a second plurality of windings 114b. A rotor 18 is rotatably received inside the stator 10 with an air gap therebetween. In the embodiment of FIG. 10, the first plurality of windings 114a that are closest to the air gap are formed from UCC foils using any of the above forming techniques including but not limited to rolling, stacking, folding, with or without cladding, forming as hollow, mixing with other copper or aluminum foils, wrapping around a copper wire or extruded copper, etc., and the second plurality of windings 114b that are further from the air gap are formed from copper wire or extruded copper without the UCC foils.

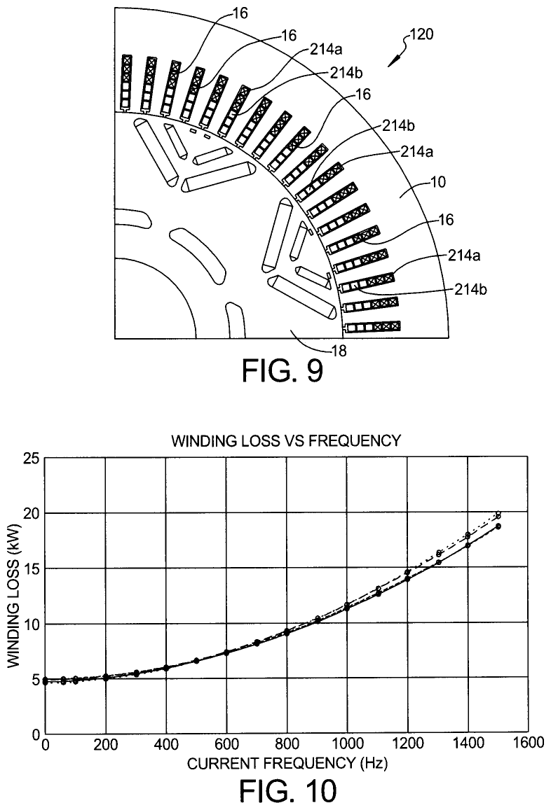

In the embodiment of FIG. 9, a cross section of a portion of an electric motor 120 is shown including a stator 10 having a plurality of grooves 16 that receive a first plurality of windings 214a and a second plurality of windings 214b. A rotor 18 is rotatably received inside the stator 10 with an air gap therebetween. In the embodiment of FIG. 9, the first plurality of windings 214a that are further from the air gap are formed with UCC foils using any of the above forming techniques including rolling, stacking, folding, with or without cladding, forming as hollow, mixing with other copper or aluminum foils, wrapping around a copper wire or extruded copper, etc, and the second plurality of windings 214b that are closer to the air gap are formed from copper wire or extruded copper without the UCC foils.

To improve electric machine efficiency, a novel electric motor is proposed to reduce machine resistive losses. The motor stator and/or rotor windings use a combination of copper/aluminum and several layers of ultra-conducting copper (UCC) tapes/foils (˜25 um thick) or UCC alone. The UCC tapes/foils can be cladded around copper bars or round wires; they also can be folded to form bar or roll shape and then covered by copper using cladding and solid plastic deformation. All of the stator and/or rotor windings can be formed by the UCC/Cu windings completely or partially based on applications and cost. If the partial winding using UCC is used, the partial windings of UCC can be placed away from the motor air gap to reduce the skin effect in order to improve high speed machine efficiency. Alternatively, in other applications, it may be desirable to use the partial windings made from UCC closer to the air gap. As described above, the UCC tape can be rolled, sandwiched or cladded with other conductive materials such as copper and aluminum to form the conductor windings. The conductor windings can be round or in bar shape.

The stator windings 14 can be formed by the UCC assisted windings which are copper/aluminum cladded by several layers of UCC. They can be in bar shape for bar-wound windings or in round shape for stranded wire windings. This type of winding is referred to as UCC assisted winding. The UCC clad winding 14 could be used for all of the stator winding as shown in FIG. 7. They also can be used partially in the stator windings as shown in FIGS. 8 and 9.

The partial UCC stator windings can be placed close to the air gap (FIG. 8) or away from the air gap (FIG. 9). For high-speed machine application, the partial winding using UCC is preferred to be placed away from the air gap. Based on testing performed as shown in the graph of FIG. 10, winding losses can be reduced up to 6.7% at low frequency if all winding uses the UCC assisted winding and winding losses can be reduced up to 3.4% at low frequency if partial of windings use the UCC assisted winding. The stator with partial UCC assisted winding away from airgap does not increase the skin effect of the windings up to 1500 Hz.

The stator windings 14 can be formed with the new UCC/Cu windings in which the UCC is folded into bar shape or round surrounded by copper. The winding also can be folded as bar shape or rolled as round shape with 100% UCC materials. This type of winding is referred as UCC assisted winding. The UCC winding bars 14 could be used for all of the stator windings as shown in FIG. 7. They also can be used partially in the stator windings as shown in FIGS. 8 and 9. The partial new stator windings can be placed close to the air gap (FIG. 8) or away from the air gap (FIG. 9). For high-speed machine applications, the partial winding is preferred to be placed away from the airgap to improve high speed machine efficiency. Based upon testing, winding loss is reduced by at least 5% at low frequency if all or partial windings use the UCC assisted winding at low speed. Further, the motor stator with UCC assisted windings do not increase skin effect of winding up to 1500 Hz.

The UCC wires 14 of the present disclosure can also be used for a rotor of the electric machines such as the rotor of a brushed DC machine, induction machine, wound field synchronous machine and claw pole machine to improve machine efficiency. The regular wires can be replaced with this new UCC formed windings 14.

Many current traction motors in electric vehicles use bar wound to improve the motor fill factor. Although the bar wound improves the low-speed machine loss, it leads to a high skin effect (e.g. resistance increased by 2 times at AC frequency above 1000 Hz), significantly increasing the loss and limiting the motor power density, speed, and torque capability. There is currently no existing material technology to balance the low frequency resistive loss reduction and high-speed skin effect. The UCC windings of the present disclosure provides the solution. The shape and total percentage of the UCC foil used in the conductor windings can be optimized based on applications and cost.

The use of the UCC foil to form the motor windings 14 increases electric conductivity and machine performance by reducing the resistive loss. In addition, the improved power density and performance of the electric motors enhance the drive system performance. The use of UCC foil to form the motor windings provides materials and design solutions for electric motors and other applications to improve the system drive cycle efficiency without suffering skin effect. The use of UCC foil to form the motor windings also reduce the electric motor size and weight.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. An electric motor, comprising:
a stator;
a rotor rotatable relative to the stator and having an air gap between the rotor and the stator, wherein at least one of the stator and the rotor include a plurality of windings formed from ultra-conducting copper foil.

2. The electric motor according to claim 1, wherein all of the plurality of windings are formed from ultra-conducting copper foil.

3. The electric motor according to claim 1, wherein the stator windings further include a plurality of windings made from copper wire.

4. The electric motor according to claim 3, wherein the plurality of windings formed from ultra-conducting copper foil are closer to the air gap than the plurality of windings made from copper wire.

5. The electric motor according to claim 3, wherein the plurality of windings formed from ultra-conducting copper foil are further from the air gap than the plurality of windings made from copper wire.

6. The electric motor according to claim 1, wherein the plurality of windings formed from ultra-conducting copper foil are combined with one of copper or aluminum.

7. The electric motor according to claim 6, wherein the plurality of windings formed from ultra-conducting copper foil combined with one of copper or aluminum includes the ultra-conducting copper foil being rolled with a copper or aluminum foil.

8. The electric motor according to claim 6, wherein the plurality of windings formed from ultra-conducting copper foil combined with one of copper or aluminum includes the ultra-conducting copper foil sandwiched with a copper or aluminum foil.

9. The electric motor according to claim 6, wherein the plurality of windings formed from ultra-conducting copper foil combined with one of copper or aluminum includes the ultra-conducting copper foil being clad with one of copper or aluminum.

10. The electric motor according to claim 6, wherein the plurality of windings formed from ultra-conducting copper foil combined with one of copper or aluminum includes the ultra-conducting copper foil being wrapped around one of a copper wire and extruded copper.

11. An electric motor, comprising:
a stator;
a rotor rotatable relative to the stator and having an air gap between the rotor and the stator, wherein at least one of the stator and the rotor include a plurality of windings formed from wire that is wrapped in ultra-conducting copper foil.

12. The electric motor according to claim 11, wherein all of the stator windings are formed from wire that is wrapped in ultra-conducting copper foil.

13. The electric motor according to claim 6, wherein the stator windings further include a plurality of windings made from copper wire.

14. The electric motor according to claim 8, Wherein the plurality of windings formed from wire that is wrapped in ultra-conducting copper foil are closer to the air gap than the plurality of windings made from copper wire.

15. The electric motor according to claim 8, wherein the plurality of windings formed from wire that is wrapped in ultra-conducting copper foil are further from the air gap than the plurality of windings made from copper wire.

16. An electric motor, comprising:
a stator;
a rotor rotatable relative to the stator and having an air gap between the rotor and the stator, wherein at least one of the stator and the rotor includes a plurality of windings formed from rolled ultra-conducting copper foil that is formed with a hollow cavity therethrough.

17. The electric motor according to claim 16, wherein all of the stator windings are formed from ultra-conducting copper foil that is clad with one of copper or aluminum.

18. The electric motor according to claim 16, wherein the stator further includes a plurality of windings made from copper wire.

19. The electric motor according to claim 18, wherein the plurality of windings formed from ultra-conducting copper that is clad with one of copper or aluminum and is formed with a hollow cavity therethrough are closer to the air gap than the plurality of windings made from copper wire.

20. The electric motor according to claim 18, wherein the plurality of windings formed from ultra-conducting copper that is clad with one of copper or aluminum and is formed with a hollow cavity therethrough are further from the air gap than the plurality of windings made from copper wire.
